(19) United States
(12) Patent Application Publication
(10) Pub. No.: US 2024/0297415 A1
(43) Pub. Date: Sep. 5, 2024

(54) UNIVERSAL BATTERY PACK AND SYSTEM USING UNIVERSAL BATTERY PACK

(71) Applicants: Deltax Co., Ltd., Seoul (KR); Nano In Teck Co., Ltd., Wonju-si (KR)

(72) Inventors: Suhun Kim, Incheon (KR); Akmaljon Alijon Ugli Palvanov, Seoul (KR)

(21) Appl. No.: 18/570,807

(22) PCT Filed: Sep. 7, 2022
(86) PCT No.: PCT/KR2022/013493

§ 371 Date: Dec. 15, 2023

(30) Foreign Application Priority Data
Sep. 14, 2021 (KR) 10-2021-0122459

(51) Int. Cl. H01M 50/509; B60L 50/60; B62J 43/10; H01M 10/0525; H01M 10/48; H01M 50/213; H01M 50/249; H01M 50/296

(52) U.S. Cl. CPC H01M 50/509; H01M 10/0525; H01M 10/482; H01M 50/213; H01M 50/249; H01M 50/296; B60L 50/60; B62J 43/10; H01M 2220/20

(57) ABSTRACT

A battery pack of the present disclosure comprises a housing; six battery modules accommodated in the housing; and a connecting module formed at one end of the housing and configured to connect to a receptacle of an external device and having six outputs. Each of the battery modules includes an output terminal and is configured to independently provide a first output voltage through the output terminal. Each of the outputs is connected in one-to-one correspondence with each output terminal of the battery module and is configured to independently relay the first output voltage to the receptacle. The six outputs are configured to be connectable in series or in parallel depending on configuration of the receptacle of the external device, and configured to provide only one of once, twice, three times, and six times the first output voltage to the external device depending on configuration of the receptacle.

### FIELD OF THE INVENTION

The present application is a priority application of Korean Patent Application No. 10-2021-0122459 filed on Sep. 14, 2021; the entire contents disclosed in the specification and drawings of said application are incorporated herein by reference.

The present disclosure relates to a universal battery pack and a system using the universal battery pack, and more particularly to using a single standard battery pack in multiple systems with different operating voltages.

### BACKGROUND OF THE INVENTION

The use of fossil energy as a power source causes environmental problems, and attempts to use electric energy as an eco-friendly form of energy are increasing. Recently, rechargeable batteries have been used in cars, kickboards and the like, but each device requires a different voltage and requires a separate battery.

### PRIOR DISCLOSURES

Korean Patent No. 10-1933449
Korean Patent No. 10-2264429
Korean Patent Application Publication No. 10-2021-0047750
Korean Patent Application Publication No. 10-2021-0004187

### DETAILED DESCRIPTIONS OF THE INVENTION

### Problems to be Solved

The present disclosure provides a standard battery pack and a system using the standard battery pack that can be used for common uses in various transportation devices, such as electric vehicles, electric bicycles, electric kickboards, golf carts, or the like.

### Technical Solutions

According to an aspect of the present disclosure, a battery pack comprises a housing; six battery modules accommodated in the housing; and a connecting module formed at one end of the housing and configured to connect to a receptacle of an external device, comprising six outputs having positive outputs and negative outputs, and a sensing unit that is connected with each of the sensing lines. Each of the battery modules includes first to seventh battery cells connected in series to each other, a first output terminal having one end that is connected to a positive electrode of the first battery cell, a second output terminal having one end that is connected to a negative electrode of the seventh battery cell, and sensing lines for monitoring statuses of the first to the seventh battery cells, wherein each of the battery modules is electrically independent and configured such that a potential between the first output terminal and the second output terminal of each of the battery modules provides a first output voltage. A positive connector of the output is connected in electrical one-to-one correspondence with other end of the first output terminal of the battery module, a negative connector is connected in electrical one-to-one correspondence with other end of the second output terminal of each of the battery modules, and the six outputs are configured to independently relay the first output voltage. The six outputs are configured to be connectable in series or in parallel depending on configuration of the receptacle of the external device.

In an embodiment, the battery cell may be a lithium-ion battery with a nominal voltage of 3.6 V to 3.8 V.

In an embodiment, the connecting module provides various configurations according to configuration of the receptacle of the external device when the connecting module is coupled to the receptacle. For example, the connecting module is configured to provide only one of following four configurations: a first configuration in which all of the six outputs are connected in series to provide a voltage of six times the first output voltage, a second configuration in which every three of the six outputs are connected in series, and two pairs of three outputs in series are connected in parallel to provide a voltage of three times the first output voltage, a third configuration in which every two of the six outputs are connected in series, and three pairs of the two outputs in series are connected in parallel to provide a voltage of twice the first output voltage; and a fourth configuration in which all of the six outputs are connected in parallel to provide the first output voltage.

In an embodiment, the six outputs may be arranged to be symmetrical when the connecting module is viewed from its front.

According to one aspect of the present disclosure, a battery pack comprises a housing; six battery modules accommodated in the housing; and a connecting module formed at one end of the housing and configured to connect to a receptacle of an external device, comprising six outputs having positive outputs and negative outputs, and a sensing unit that is connected with each of the sensing lines. Each of the battery modules includes first to eighth battery cells connected in series to each other, a first output terminal having one end that is connected to a positive electrode of the first battery cell, a second output terminal having one end that is connected to a negative electrode of the eighth battery cell, and sensing lines for monitoring statuses of the first to the eighth battery cells, wherein each of the battery modules is electrically independent and configured such that a potential between the first output terminal and the second output terminal of each of the battery modules provides a first output voltage. A positive connector of the output is connected in electrical one-to-one correspondence with other end of the first output terminal of the battery module, a negative connector is connected in electrical one-to-one correspondence with other end of the second output terminal of each of the battery modules, and the six outputs are configured to independently relay the first output voltage. The six outputs are configured to be connectable in series or in parallel depending on configuration of the receptacle of the external device.

In an embodiment, the battery cell may be a lithium iron phosphate battery with a nominal voltage of 3.1 V to 3.3 V.

In an embodiment, the connecting module provides various configurations according to configuration of the receptacle of the external device when the connecting module is coupled to the receptacle. For example, the connecting module is configured to provide only one of following four configurations: a first configuration in which all of the six outputs are connected in series to provide a voltage of six times the first output voltage, a second configuration in which every three of the six outputs are connected in series, and two pairs of three outputs in series are connected in parallel to provide a voltage of three times the first output voltage, a third configuration in which every two of the six outputs are connected in series, and three pairs of the two outputs in series are connected in parallel to provide a voltage of twice the first output voltage; and a fourth configuration in which all of the six outputs are connected in parallel to provide the first output voltage. In an embodiment, the six outputs may be arranged to be symmetrical when the connecting module is viewed from its front.

According to one aspect of the present disclosure, a battery pack comprises a housing; six battery modules accommodated in the housing; and a connecting module formed at one end of the housing and configured to connect with a receptacle of an external device and having six outputs. Each of the battery modules includes an output terminal and is configured to independently provide a first output voltage through the output terminal. Each of the outputs is connected in one-to-one correspondence with each output terminal of the battery module and is configured to independently relay the first output voltage to the receptacle. The six outputs are configured to be connectable in series or in parallel depending on configuration of the receptacle of the external device, and configured to provide only one of once, twice, three times, and six times the first output voltage to the external device depending on configuration of the receptacle.

According to one aspect of the present disclosure, a battery system is equipped with a battery pack including six battery modules and a connecting module; and a receptacle electrically connectable with the battery pack; and comprises a plurality of devices for obtaining a drive voltage when the battery pack and the receptacle are connected. Each of the battery modules comprises an output and is configured to independently provide a first output voltage through the output, and the connecting module is configured to be connected with the receptacle of the plurality of devices to independently relay the first output voltage from each of the battery modules to the receptacle. The plurality of devices include at least two of following configurations: a first device requiring a first drive voltage for drive and including a first receptacle, the first receptacle including six output connectors each electrically connected with the output of the battery module, the output connectors being connected in series in units of three, and two pairs of the output connectors of which the three output connectors are connected in series being connected in parallel so that the first receptacle is configured to convert a voltage of three times the first output voltage to the first drive voltage; a second device requiring a second drive voltage for drive and including a second receptacle, the second receptacle including six output connectors each electrically connected with the output of the battery module, and all of the output connectors being connected in parallel and configured so that the first output voltage is output as the second drive voltage; a third device requiring a third drive voltage for drive and including a third receptacle, the third receptacle including six output connectors each electrically connected with the output of the battery module, the output connectors being connected in series in units of two, and three pairs of the output connectors of which the two output connectors are connected in series being connected in parallel so that the third receptacle is configured to convert a voltage of twice the first output voltage to the third drive voltage; and a fourth device requiring a fourth drive voltage for drive and including a fourth receptacle, the fourth receptacle including six output connectors each electrically connected with the output of the battery module, all of the output connectors being connected in series, and the fourth receptacle being configured to convert a voltage of six times the first output voltage to the fourth drive voltage.

The battery pack of the present disclosure allows a single standard battery with unified specifications to be used in different transportation devices requiring different voltages, thereby facilitating battery management and relieving transportation device manufacturers of the difficulty of battery quality management.

### BRIEF DESCRIPTION OF THE DRAWINGS

FIG. 1 is a conceptual view of an environment using a battery pack according to an embodiment of the present disclosure.

FIG. 2A is a conceptual view of a battery pack according to an embodiment of the present disclosure.

FIG. 2B is a conceptual view illustrating a connection between one battery module of a battery pack and an external device according to an embodiment of the present disclosure.

FIG. 2C is a conceptual view of a battery pack according to an embodiment of the present disclosure.

FIG. 3A is a partial view of a battery pack according to an embodiment of the present disclosure.

FIG. 3B is a partial view of a battery pack according to an embodiment of the present disclosure.

FIG. 4A is an exemplary view of a receptacle of a transportation device connected to a battery according to an embodiment of the present disclosure.

FIG. 4B is an exemplary view of a combination of a battery and a receptacle according to an embodiment of the present disclosure.

FIGS. 4C-4F are exemplary views illustrating a rear side of a receptacle according to an embodiment of the present disclosure.

FIG. 5 is an exemplary view of a battery charging device according to an embodiment of the present disclosure.

FIG. 6 is an exemplary view of a use of two or more battery packs according to an embodiment of the present disclosure.

### DESCRIPTION OF THE INVENTION

Hereinafter, the present disclosure will be described in detail with reference to the drawings. In describing the present disclosure, detailed descriptions of known functions or configurations that may unnecessarily obscure the essence of the present disclosure are omitted. Furthermore, the following embodiments may be modified into various other forms, and the scope of the technical ideas of the present disclosure is not limited to the following embodiments. Instead, these embodiments are provided to enhance the faithfulness and completeness of the present disclosure and to effectively convey the technical ideas of the present disclosure to those skilled in the art.

The technology described in the present disclosure is not intended to be limited to any particular embodiment and should be understood to include various modifications, equivalents, and/or alternatives to the embodiments of the present disclosure.

With respect to the description in the drawings, similar reference signs may be used for similar components.

In the present disclosure, expressions such as “has,” “may have,” “includes,” or “may include” refer to the presence of a feature (e.g., a numerical value, function, operation, or component such as a part) and do not exclude the presence of additional features. In the present disclosure, expressions such as “A or B,” “at least one of A and/or B,” or “one or more of A and/or B” may include any possible combination of items listed together. For example, “A or B,” “at least one of A and B,” or “at least one of A or B” may refer to a case that (1) includes at least one A, (2) includes at least one B, or (3) includes both at least one A and at least one B.

As used in the present disclosure, expressions such as “first,” “second,” “the first,” or “the second,” may refer to various components in any order and/or order of importance, and are used to distinguish one component from another and are not intended to limit such components.

When a component (e.g., a first component) is referred to as being “operatively or communicatively coupled with/to” or “connected to” other component (e.g., a second component), it is to be understood that such component may be directly connected to such other component, or may be connected through another component (e.g., a third component). On the other hand, when a component (e.g., a first component) is referred to as being “directly coupled” or “directly connected” to other component (e.g., a second component), it may be understood that no other component (e.g., a third component) exists between the component and the other component.

As used in the present disclosure, the expression “configured to (or set up)” may be used interchangeably with, for example, “suitable for,” “having the capacity to,” “designed to,” “adapted to,” “made to,” or “capable of,” depending on the context. The term “configured (or set up) to” may not necessarily mean “specifically designed to” in hardware. Instead, in some situations, the phrase “a device configured to” may mean that the device is “capable of” working with other devices or parts. For example, the phrases “a processor configured (or set up) to perform A, B, and C,” and “a module configured (or set up) to perform A, B, and C” may refer to a dedicated processor (e.g., an embedded processor) for performing those actions, or a generic-purpose processor (e.g., a CPU or application processor) capable of performing those actions by executing one or more software programs stored on a memory device.

The prior arts described in the present disclosure are incorporated herein by reference in its entirety.

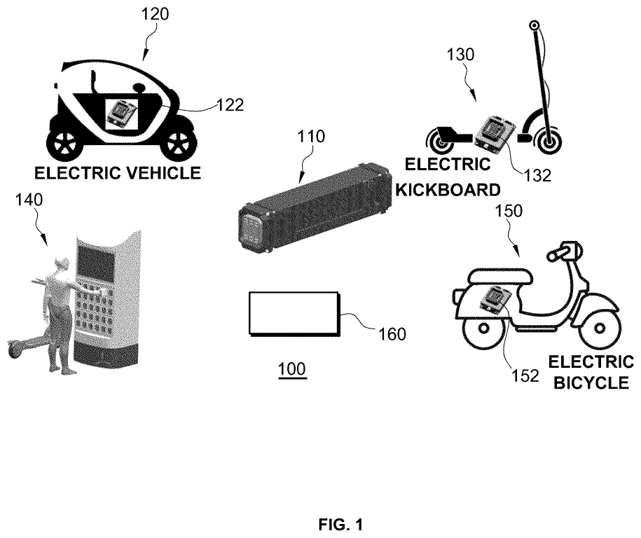

FIG. 1 is a conceptual view of an environment 100 using a battery pack 110 according to an embodiment of the present disclosure. Referring to FIG. 1, the environment 100 includes a battery pack 110, various transportation devices (an electric vehicle 120, an electric kickboard 130, and an electric bicycle 150), and a charging device 140. The electric vehicle 120, the electric kickboard 130, and the electric bicycle 150 are examples of transportation devices, and it will be understood that any device powered by an electric battery, not just transportation devices, can be included in the environment 100. In the environment 100, a user may share the battery pack 110 with the electric vehicle 120, the electric kickboard 130, and the electric bicycle 150, and reuse the battery pack 110 by charging it via a charging device 140.

The electric vehicle 120, the electric kickboard 130, and the electric bicycle 150 each have receptacles 122, 132, 152, respectively. The electric vehicle 120, the electric kickboard 130, and the electric bicycle 150 may be mechanically and/or electrically connected to the battery pack 110 via the receptacles 122, 132, 152, respectively, and may receive power from the battery pack 110. In an embodiment, the receptacles 122, 132, 152 may be mechanically connected to the battery pack 110. Connection portions of the receptacles 122, 132, 152 and the battery pack 110 may have a same shape.

In an embodiment, different voltages may be required for operation of the electric vehicle 120, the electric kickboard 130, and the electric bicycle 150. For example, the electric vehicle 120 may require a drive voltage of 72 V (e.g., a first demand voltage or first drive voltage), the electric kickboard 130 may require a drive voltage of 24 V (e.g., a second demand voltage or second drive voltage), and the electric bicycle 150 may require a drive voltage of 48 V (e.g., a third demand voltage or third drive voltage). Other devices (not shown) may require a drive voltage of 144 V (e.g., a fourth demand voltage or a fourth drive voltage). In addition, a voltage between 5 V and 30 V (e.g., a fifth demand voltage, fifth drive voltage) may be required to drive other devices 160, such as laptops, smartphones, camping equipment, or the like. Conventionally, in order to use electric vehicles 120, electric kickboards 130, electric bicycles 150, and other devices 160, battery packs each with different voltages had to be used. According to the present disclosure, since the electric vehicle 120, the motorized scooter 130, and the electric bicycle 150 each have receptacles 122, 132, 152, respectively, and the receptacles 122, 132, 152 can be mechanically and/or electrically connected to a same battery pack 110, a single battery pack 110, i.e., the same battery pack 110, can be utilized to power the electric vehicle 120, the motorized scooter 130, the electric bicycle 150, and the other devices 160, respectively. Therefore, by producing and using battery packs (110) of a same specification, it is possible to drive various devices with different operating voltages. At this time, since different voltages are required for operation of the electric vehicle 120, the electric kickboard 130, and the electric bicycle 150, the receptacles 122, 132, 152 may be configured to supply voltages required for driving the electric vehicle 120, the electric kickboard 130, and the electric bicycle 150 from the battery pack 110. A detailed structure of the receptacles 122, 132, 152 will be discussed later.

In an embodiment, the charging device 140 may be installed in various locations that are easily accessible to users. For example, the charging device 140 may be installed at various locations such as convenience stores, bakeries, grocery stores, restaurants, subway stations, or the like. Users may borrow, return, or recharge the battery pack 110 at any time via the charging device 140. The battery pack 110 may have a unique identification symbol (e.g., identification number, barcode, QR code, or the like). The charging device 140 may monitor a battery status via a unique identification symbol on the battery pack 110. The charging device 140 is configured to charge a plurality of battery packs 110 simultaneously. For example, the charging device 140 may include a plurality of terminals, each of which may be mechanically/electrically connected with a respective battery pack 110.

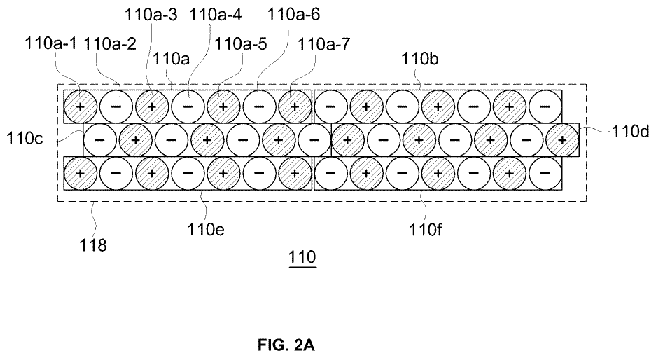

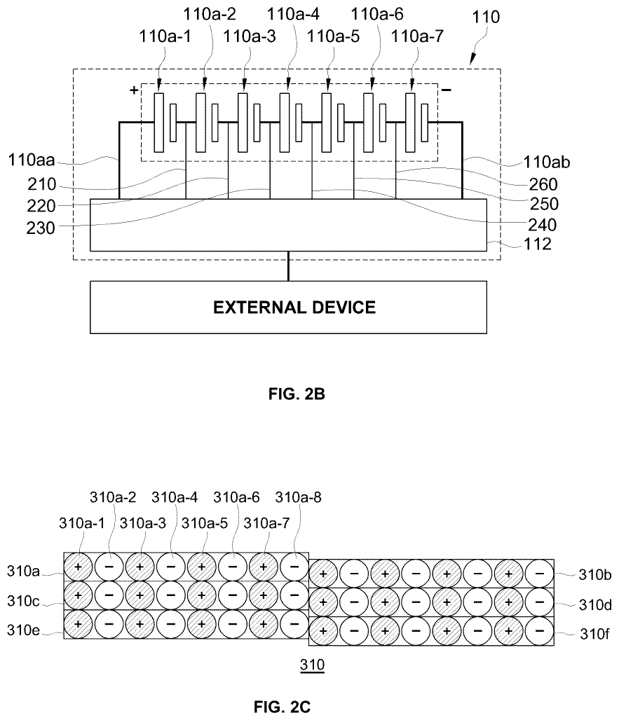

FIG. 2A is a conceptual view of a battery pack 110 according to an embodiment of the present disclosure.

Referring to FIG. 2A, the battery pack 110 includes a housing 118 and a plurality of battery modules 110a-110f accommodated in the housing 118. For example, the number of battery modules 110a-110f may be 6. The number of battery modules may be changed. In an embodiment, each of the battery modules 110a-110f may include a plurality of battery cells for lithium secondary batteries. Lithium secondary batteries refer to, for example, but are not limited to, nickel, manganese, cobalt, and ternary series secondary batteries.

Referring to FIG. 2A, the first to sixth battery modules 110a-110f may include seven battery cells 110a-1-110a-7. The number of battery cells 110a-1-110a-7 may be appropriately adjusted according to a nominal voltage of a single battery cell. While cylindrical battery cells 110a-1110a-7 are illustrated in FIG. 2A, rechargeable battery cells of various shapes, such as pouch-type or prismatic-type cells, are encompassed within the present disclosure. In an embodiment, the first battery module 110a includes seven battery cells 110a-1-110a-7. Each of the battery cells 110a-1-110a-7 may have a nominal voltage of about 3.6 V to 3.8 V. The seven battery cells 110a-1-110a-7 of the first battery module 110a are connected in series. Accordingly, the first battery module 110a may be configured to supply a voltage of 24 V. The first battery module 110a includes a first output terminal 110aa and a second output terminal 110ab.

Referring to FIG. 2B, the first output terminal 110aa may be electrically connected to a positive electrode of the first battery module 110a, and the second output terminal 110ab may be electrically connected to a negative electrode of the first battery module 110a. Therefore, the first output terminal may be referred to as a positive output terminal and the second output terminal may be referred to as a negative output terminal. For example, the first output terminal 110aa may be electrically connected to a positive electrode of any one of the battery cells 110a-1-110a-7 of the first battery module 110a, and the second output terminal 110ab may be electrically connected to a negative electrode of any one of the battery cells 110a-1-110a-7 of the first battery module 110a. In FIG. 2B, for convenience, only the output terminals 110aa, 110ab of the first battery module 110a are shown, but for the battery pack 110 shown in FIG. 2A, each of the six battery modules 110a-110f of the battery pack 110 has two output terminals, such that the battery pack 110 may have a total of twelve output terminals. The second to sixth battery modules 110b-110f may also be formed in a same manner as the first battery module 110a. Accordingly, the battery pack 110 may include six battery modules 110a-110f that provide a voltage of 24 V. The first battery module 110a will be described below as an example.

FIG. 2B is a conceptual view illustrating a connection between one battery module 110a of a battery pack 110 and an external device according to an embodiment of the present disclosure. The external device may include, for example, an electric vehicle 120, an electric kickboard 130, an electric bicycle 150, and another device 160. The battery pack 110 may include a connecting module 112, and the connecting module 112 may be mechanically/electrically coupled to the external device. For convenience of explanation, only the first battery module 110a, among the six battery modules 110a-110f, is shown and described.

In an embodiment, the first battery module 110a includes a first output terminal 110aa and a second output terminal 110ab. One end of the first output terminal 110aa may be electrically connected to a positive electrode of the first battery module 110a, and one end of the second output terminal 110ab may be electrically connected to a negative electrode of the first battery module 110a. The output terminals 110aa, 110ab are terminals for supplying power to an external device via receptacles 122, 132, 152 of external devices, such as an electric vehicle 120, an electric kickboard 130, and an electric bicycle 150. Thus, the other end of the first output terminal 110aa and the other end of the second output terminal 110ab may be electrically connected to the connecting module 112.

The first battery module 110a may further include sensing lines 210-260. One end of the sensing lines 210-260 may be electrically connected between each of the battery cells 110a-1-110a-7 that are connected in series. For example, one end of a first sensing line 210 may be electrically connected between the first and second battery cells 110a-1, 110a-2; one end of a second sensing line 220 may be electrically connected between the second and third battery cells 110a-2, 110a-3; one end of a third sensing line 230 may be electrically connected between the third and fourth battery cells 110a-3, 110a-4; one end of a fourth sensing line 240 may be electrically connected between the fourth and fifth battery cells 110a-4, 110a-5; one end of a fifth sensing line 250 may be electrically connected between the fifth and sixth battery cells 110a-5, 110a-6; and one end of a sixth sensing line 260 may be electrically connected between the sixth and seventh battery cells 110a-6, 110a-7, respectively. Since sensing lines 210-260 are present between the seven battery cells 110a-1-110a-7, and in an embodiment, there may be six sensing lines.

The other end of the sensing lines 210-260 may be electrically connected to the connecting module 112. The sensing lines 210-260 may be lines for monitoring and balancing a state of each of the battery cells 110a-1-110a-7, e.g., current, voltage, or the like. The output terminals 110aa, 110ab may be used as sensing lines, and although not shown, a separate sensing line may be arranged at one end of a battery cell that is connected to the output terminals 110aa, 110ab. In this case, there may be 8 sensing lines.

The output terminals 110aa, 110ab and the sensing lines 210-260 of the battery module 110a are electrically connected with the connecting module 112, respectively.

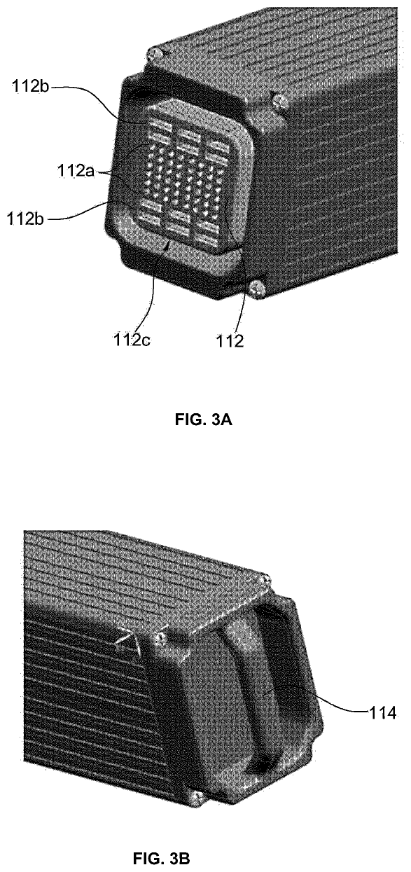

In an embodiment, the second to sixth battery modules 110b-110f may also be formed in a same manner as the first battery module 110a, so that the battery pack 110 may have 12 output terminals and 36 (or 48) sensing lines. In FIG. 3A, 48 sensing units 112a corresponding to the sensing lines are shown.

FIG. 2C is a conceptual view of a battery pack 310 according to an embodiment of the present disclosure.

Referring to FIG. 2C, the battery pack 310 includes a plurality of battery modules 310a-310f. For example, the number of battery modules 310a-310f may be 6. The number of battery modules may be changed. In an embodiment, each of the battery modules 310a-310f may include a plurality of lithium iron phosphate battery cells in which a positive electrode material is iron phosphate. The first to sixth battery modules 310a-310f may include eight battery cells 310a-1-310a-8. Each of the battery cells 310a-1-310a-8 may have a nominal voltage of about 3.1 V to 3.3 V. The eight battery cells 310a-1-310a-8 of the first battery module 310a are connected in series. Accordingly, the first battery module 310a may be configured to supply a voltage of 24 V. Except for the nominal voltage and number of each of the battery cells 310a-1-310a-8, its structure is similar to that shown in FIGS. 2A and 2B. That is, although not shown, each of the battery modules 310a-310f may have two output terminals (a positive electrode, a negative electrode), and sensing lines for monitoring a status of each of the battery cells 310a-1-310a-8 may be arranged between adjacent battery cells. Further detailed descriptions of the output terminals and the sensing lines are omitted.

In another embodiment, where a single battery module is configured to provide a voltage of about 24 V, it will be understood that the number of battery cells can be changed depending on the nominal voltage of the battery cells. The present disclosure configures six battery modules configured to provide a voltage of about 24 V into a single battery pack 110, 310, such that there is an advantage that the single battery pack 110, 310 can be used for a plurality of various devices with different demand voltages.

FIG. 3A is a partial view of a battery pack 110 according to an embodiment of the present disclosure. Referring to FIG. 3A, a connecting module 112 is arranged at one end of the battery pack 110. One end of the connecting module 112 may be electrically connected to the output terminal and the sensing line of the battery modules 110a-110f, and the other end of the connecting module 112 may be coupled to the receptacles 122, 132, 152. The body of the connecting module 112 may be formed of an insulating material. The connecting module 112 includes sensing units 112a for electrical connection with sensing lines and outputs 112b for electrical connection with output terminals. One of the outputs 112b may include a positive output (not shown) and a negative output (not shown). The positive output may be electrically connected to a first output terminal of the battery modules 110a-110f, and the negative output may be electrically connected to a second output terminal of the battery modules 110a-110f. The connecting module 112 may further include a retainer 112c for maintaining a connection with the receptacles 122, 132, 152. In FIG. 3A, the sensing units 112a and the outputs 112b are shown as concave, but these may also have a protruding shape. Shapes of the sensing units 112a and the outputs 112b may be changed to match shapes of the receptacles 122, 132, 152. In an embodiment, the number of the sensing units 112a and outputs 112b may be equal to the number of the sensing lines and output terminals of the battery modules 110a-110f, respectively. For example, the number of the sensing units 112a may be 36 or 48 and the number of the outputs 112b may be 12. The sensing units 112a and the outputs 112b are electrically independent. In an embodiment, a body of the connecting module 112 is formed of an insulating material, and the sensing units 112a and the outputs 112b are electrically connected with the sensing lines and output terminals of the battery modules 110a-110f, respectively. For example, the sensing lines and output terminals of the battery modules 110a-110f may be connected with respective output cables (not shown), ends of the output cables may be pressed and connected to terminals having electrical conductivity, and the pressed terminals can be inserted into respective openings of the connecting modules 112.

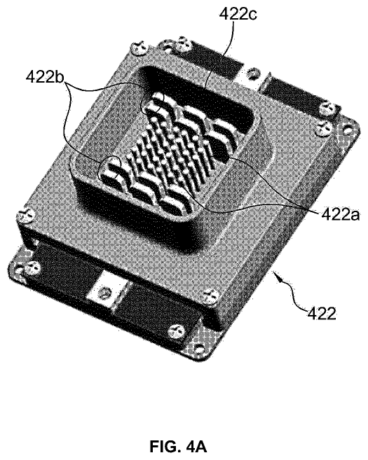

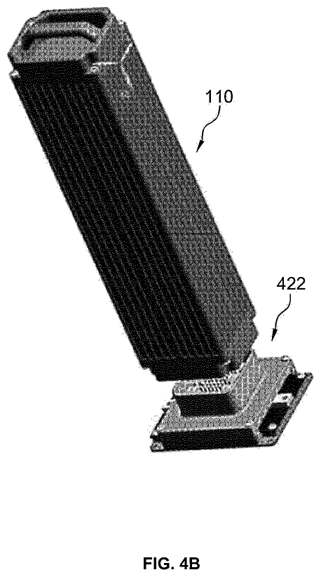

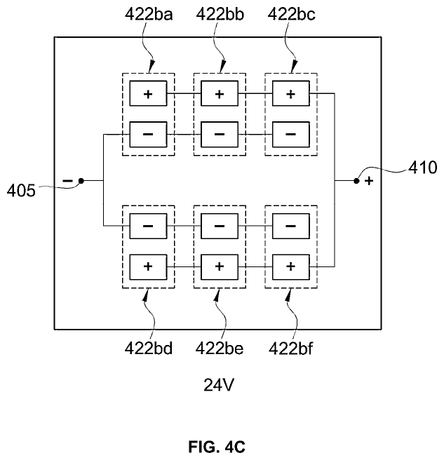

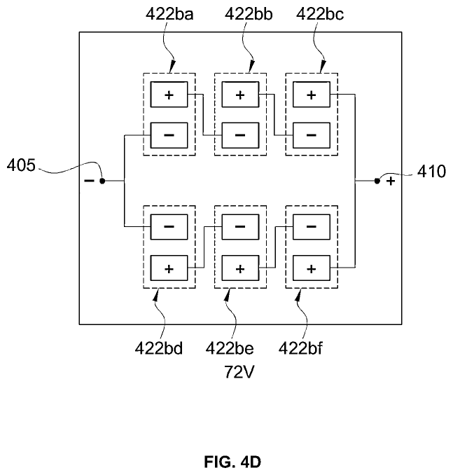

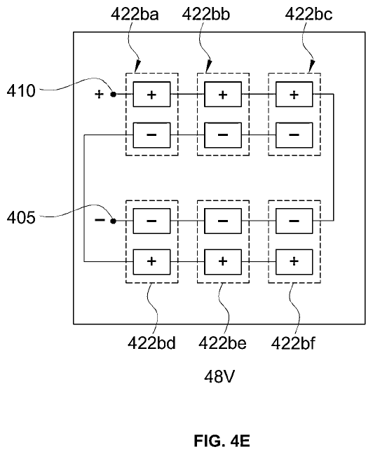

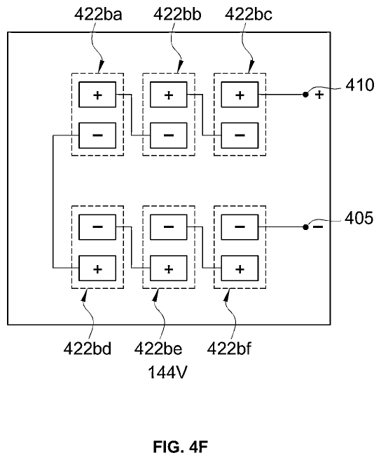

In an embodiment, the plurality of outputs 112b may be symmetrically arranged so as to be in a same arrangement even when the connecting module 112 rotates. The plurality of outputs 112b may be arranged to achieve point symmetry or line symmetry when the connecting module 112 is viewed from its front. For example, the output 112b may be configured with an arrangement of negative electrodes and positive electrodes that is up-down symmetrical. In this case, there is no problem with electrical connection even when the connecting module 112 is rotated 180 degrees and is inserted into the receptacles 122, 132, 152 in any orientation. The arrangement of negative electrodes and positive electrodes that is up-down symmetrical is exemplified in FIGS. 4C-4F. However, in addition to the examples shown in FIGS. 4C-4F, the outputs 112B may be arranged in various symmetrical configurations. For example, the outputs 112b may be arranged in a circular (or hexagonal) pattern with one point as a center. For example, there may be six outputs 112b arranged at a 60-degree angle.

Referring again to FIGS. 2A, 2B, 2C, and 3A, the battery packs 110, 310 include six battery modules 110a-110f, 310a-310f that provide a voltage of 24 V. The battery packs 110, 310 are configured to provide various voltages depending on a connection of the six battery modules 110a-110f, 310a-310f, and a series, parallel connection of the six battery modules 110a-110f, 310a-310f is not configured on a side of the battery packs 110, 310, but on a side of an external device that uses the battery packs 110, 310. That is, the output terminals or connecting modules of the battery packs 110, 310 may be configured to provide various voltages (e.g., 24 V, 48 V, 72 V, 144 V) by being variably connected in series or parallel externally. Here, 24V is an exemplary voltage, which can be called a first output voltage. In addition, it will also be understood that the output voltage of one battery module can be regulated by a battery pack manufacturer. Furthermore, providing a voltage of 24 V does not mean exactly 24 V, but is understood to mean providing a voltage between about 23 V and 26 V. Using a single battery pack for various devices with different demand voltages will be described in detail later.

FIG. 3B is a partial view of a battery pack 110 according to an embodiment of the present disclosure. Referring to FIG. 3B, a handle 114 may be formed on the other end of the battery pack 110. A user can move the battery pack 110 using the handle 114.

FIG. 4A is an exemplary view of a receptacle 422 of a transportation device connected to a battery according to an embodiment of the present disclosure. FIG. 4B is an exemplary view of a coupling of a battery pack 110 and a receptacle 422 according to an embodiment of the present disclosure.

Referring to FIGS. 4A and 4B, a front of the receptacle 422 is configured to be mechanically coupled to the connecting module 112 of the battery pack 110. As shown in FIG. 4A, a plurality of sensing connectors 422a and a plurality of output connectors 422b may be formed on the front of the receptacle 422.

In an embodiment, a bottom portion of the front of the receptacle 422 may include an insulating member. The sensing connectors 422a and the output connectors 422b are formed from electrical conductors and may be formed through the bottom portion. In an embodiment, a series or parallel connections of the output connectors 422b may be made electrically by wiring or a bus bar on a rear side of the receptacle 422. Alternatively, a substrate may be attached to the rear side of the receptacle 422 to allow for series or parallel connections of the output connectors 422b.

Thus, the battery packs 110, 310 may provide various voltages simply by only inserting the battery packs 110, 310 into the receptacle 422, without separately adjusting connections of the output terminals of the battery packs 110, 310. This will be discussed later with reference to FIGS. 4C-4F.

The sensing connectors 422a and the output connectors 422b are electrically connected with the sensing units 112a and the outputs 112b, respectively. The sensing connectors 422a and the output connectors 422b correspond to the sensing units 112a and the outputs 112b, respectively. For example, the sensing connectors 422a and the output connectors 422b, and the sensing units 112a and the outputs 112b may be in a plug and socket-like relationship. Alternatively, the coupling of the connecting module 112 and the receptacle 422 may be a plug and socket-like relationship. Therefore, the number of the sensing connectors 422a and output connectors 422b may be equal to the number of the sensing units 112a and outputs 112b, respectively. For example, there may be six output connectors 422b.

The output connectors 422b may include a positive output connector (not shown) and a negative output connector (not shown). The positive output connector may be electrically connected to the positive output, and the negative output connector may be electrically connected to the negative output.

In an embodiment, the sensing connectors 422a and the output connectors 422b may have shapes corresponding to the sensing units 112a and the outputs 112b, respectively. For example, if the sensing units 112a and the outputs 112b are formed to protrude, the sensing connectors 422a and the output connectors 422b may have concave shapes to accommodate the sensing units 112a and the outputs 112b. If the sensing units 112a and the outputs 112b are formed to be concave, the sensing connectors 422a and the output connectors 422b may have protruding shapes to be accommodated in the sensing units 112a and the outputs 112b. The receptacle 422 may further include an edge 422c for coupling with the connecting module 122. The edge 422c is formed to surround the sensing connectors 422a and the output connectors 422b. The edge 422c may be configured to correspond to the retainer 112c and be coupled to the retainer 112c. In FIG. 4A, 36 sensing connectors 422a are shown.

In an embodiment, the receptacle 422 may be electrically/mechanically connected to an external device, such as a battery management system (BMS) (not shown) of an electric vehicle 120, an electric kickboard 130, and an electric bicycle 150. The BMS may perform functions to gather and analyze information about the battery pack 110, the battery modules 110a-110f, and the battery cells 110a-1-110a-7, and supply/control power for external devices from the battery pack 110. The BMS may include a power relay assembly (PRA). By mechanically coupling the receptacle 422 and the connecting module 112 of the battery pack 110 together, an electrical connection between the battery modules 110a-110f of the battery pack 110 may be formed according to a voltage required by the external device. For example, according to electrical connection passageways of the rear side of the receptacle 422, a connection of the battery modules 110a-110f is determined by the receptacle 422 of the external device so as to provide a voltage of any one of 24 V, 48 V, 72 V, and 144 V.

FIGS. 4C-4F exemplary views illustrating a rear side of a receptacle according to an embodiment of the present disclosure. For convenience of description, a rear side corresponding to the sensing connectors 422a is omitted. An arrangement of the positive electrodes (+) and the negative electrodes (−) shown in FIGS. 4C-4F is exemplary, and it will be understood that such arrangement may be changed depending on such as locations of output terminals of the battery pack 110. FIGS. 4C-4F illustrate six pairs of the output connecting modules 422ba-422bf, each having a positive electrode (+) and a negative electrode (−), wherein a pair of a positive electrode and a negative electrode may correspond to a first output terminal and a second output terminal of a single battery module, respectively. That is, a pair of a positive electrode and a negative electrode may provide a voltage of 24 V, respectively. As described above, 24V is an exemplary voltage, which can be called a first output voltage.

In an embodiment, the output connectors 422ba-422bf may be configured with an arrangement of negative electrodes and positive electrodes that is up-down symmetrical. That is, as shown in FIGS. 4C-4F, the output connectors 422ba-422bc and the output connectors 422bd-422bf are arranged symmetrically. The negative electrodes and positive electrodes of the outputs of the battery packs 110, 310 may also be arranged as shown in FIGS. 4C-4F. According to this symmetrical arrangement, it is easy to connect the battery packs 110, 310 to the receptacle 422 since the arrangement is the same even when rotated 180 degrees.

Referring to FIG. 4C, the six pairs of positive electrodes (+) and negative electrodes (−) 422ba-422bf are connected in parallel. Accordingly, output terminals 405, 410 in FIG. 4C may provide a voltage of 24 V.

Referring to FIG. 4D, the output connectors 422ba-422bc, 422bd-422bf including the positive electrodes (+) and negative electrodes (−) are connected in series in units of three, and two pairs 422ba-422bc, 422bd-422bf, of which the three output connectors are connected in series, are connected in parallel. Accordingly, output terminals 405, 410 in FIG. 4d may provide a voltage of 72 V. Since FIG. 4d is exemplary, it will be understood that other series/parallel connections other than those shown in FIG. 4D are possible so as to provide 72 V. For example, the output connectors may provide 72 V even when the output connectors are connected in parallel in two units, and three pairs, of which the two output connectors are connected in parallel, are connected in series.

Referring to FIG. 4E, the output connectors 422ba-422bd, 422bb-422bf including the positive electrodes (+) and negative electrodes (−) are connected in series in two units, and three pairs 422ba-422bc, 422bd-422bf, of which the two output connectors are connected in series, are connected in parallel. Accordingly, the output terminals 405, 410 in FIG. 4E may provide a voltage of 48 V. Since FIG. 4E is exemplary, it will be understood that other series/parallel connections other than those shown in FIG. 4E are possible so as to provide 48 V. For example, the output connectors may provide 48 V even when the output connectors are connected in parallel in units of three, and two pairs, of which the three output connectors are connected in parallel, are connected in series.

Referring to FIG. 4F, six series connectors 422ba-422bf, including a positive electrode (+) and a negative electrode (−), are connected in series to each other. Accordingly, output terminals 405, 410 in FIG. 4F may provide a voltage of 144 V.

In an embodiment, the output terminals 405, 410 in FIGS. 4C-4F may be electrically connected to a driver (not shown), such as a BMS or a motor of a device equipped with a receptacle 422, and may be configured to provide a voltage required by each of devices.

In an embodiment, a rear side of the receptacle 422 may include at least one of a printed circuit board (PCB), wiring formed on the PCB, and bus bars. However, it will be understood that the electrical connections at the rear side of the receptacle 422 are not limited to wiring or bus bars, and, for example, the electrical connections of the six pairs 422ba-422bf of positive electrodes (+) and negative electrodes (−) may be implemented using technology well-known to those skilled in the art.

As such, a variety of external devices with different drive voltages can be driven with a single battery pack 110 by using a receptacle 422 that connect the output terminals of the battery modules 110a-110f of a single battery pack 110 in different series and parallel relationships. That is, the electric vehicle 120, the electric kickboard 130, and the electric bicycle 150, or the like, may receive a desired voltage from the battery pack 110 through different receptacles 122, 132, 152 in case that they have different demand voltages.

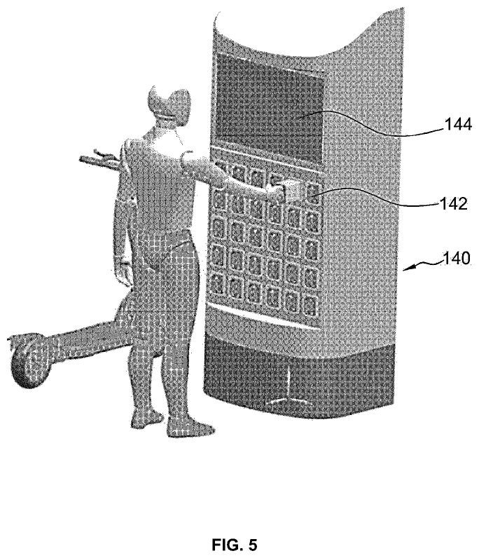

FIG. 5 is an exemplary view of a battery charging device 140 according to an embodiment of the present disclosure.

Referring to FIG. 5, the charging device 140 includes a plurality of compartments 142 and a display 144. Although not shown, the charging device 140 may further include a processor, a communication module, or the like. The compartment 142 stores the battery pack 110. A receptacle (not shown) is arranged inside the compartment 142, and the compartment 142 is configured to be electrically connected with and charge the battery pack 110. The display 144 may provide a user with information about the battery pack 110. The charging device 140 may be installed and used in various locations, like with vending machines. The charging device 140 may be configured to be equipped with a separate charging unit (not shown) or connected to a power source by wire to charge the battery pack 110.

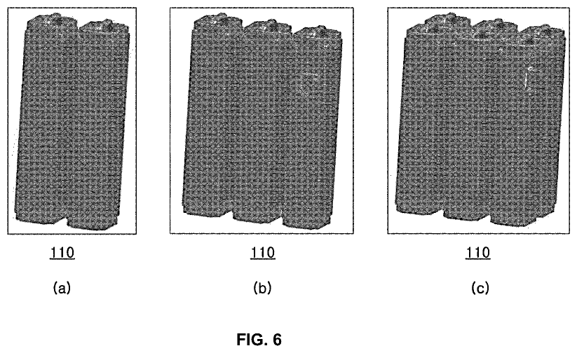

FIG. 6 is an exemplary view of a use of two or more battery packs according to an embodiment of the present disclosure. Referring to FIG. 6, two or more battery packs 110 may be used together. This can increase usage time of the battery pack 110. In an embodiment, a battery pack may be implemented to include battery modules in multiples of six within a single battery. For example, while FIGS. 2A and 2C illustrate a battery pack including six battery modules, a battery pack may include 6, 12, 24, or more battery modules.

According to the present disclosure, voltages of 24V, 48V, 72V, and 144V may be provided from a single battery pack. Extending upon this, it is also possible to manufacture a battery pack that provides voltages of N V, 2×N V, 3×N V, and 6×N V. For example, a single battery module may include a plurality of battery cells to provide a voltage of N V and is equipped with two output terminals; and a battery pack may include six battery modules. The receptacle equipped with a mobile device can provide a voltage of: 6×N V for all six battery modules in series; 2×N V for three pairs of battery modules in parallel with two battery modules in series; 3×N V for two pairs of battery modules in parallel with three battery modules in series; and N V for all battery modules in parallel. In other words, according to the present disclosure, it is allowed for a single battery pack to provide a required voltage to a mobile device based on a receptacle with which a mobile device is equipped.

According to the present disclosure, a manufacturer of a mobile device powered by a secondary battery may manufacture and sell a mobile device equipped with a receptacle that is coupled to a battery pack according to the present disclosure. The receptacle is configured to connect the output terminals of the battery pack in series and parallel according to a required voltage to provide the required voltage. Accordingly, a manufacturer can sell a mobile device without a battery pack, and a user can easily subscribe to (buy or rent) a battery pack separately and install the battery pack on the mobile device to use the mobile device.

According to the present disclosure, a user can use the same battery pack for a first transportation device requiring a first drive voltage and a second transportation device requiring a second drive voltage that is different from the first drive voltage. Accordingly, a manufacturer of the first transportation device and the second transportation device may manufacture the first transportation device and the second transportation device without having to consider which battery pack to use. Battery pack manufacturers can also improve production efficiency by producing one type of battery pack instead of manufacturing a variety of battery packs with a fixed supply voltage.

Although the embodiments have been described by limited drawings as above, those skilled in the art may apply various technical modifications and variations based on the above. For example, even if the described technologies are performed in a different order from the described method, and/or components such as the described system, structure, device, and circuit are combined or mixed in a different form from the described method, or replaced by other components or equivalents, appropriate results can be achieved.

Accordingly, other implementations, other embodiments, and those equivalent to the claims fall within the scope of the claims described below.

What is claimed is:

1. A battery pack comprising:
a housing;
six battery modules accommodated in the housing, each of the battery modules including first to seventh battery cells connected in series to each other, a first output terminal having one end that is connected to a positive electrode of the first battery cell, a second output terminal having one end that is connected to a negative electrode of the seventh battery cell, and sensing lines for monitoring statuses of the first to the seventh battery cells, wherein each of the battery modules is electrically independent and configured such that a potential between the first output terminal and the second output terminal of each of the battery modules provides a first output voltage; and
a connecting module formed at one end of the housing and configured to connect to a receptacle of an external device, comprising six outputs having positive outputs and negative outputs, and a sensing unit that is connected with each of the sensing lines, a positive connector of the output being connected in electrical one-to-one correspondence with other end of the first output terminal of the battery module, a negative connector being connected in electrical one-to-one correspondence with other end of the second output terminal of each of the battery modules, and the six outputs being configured to independently relay the first output voltage,
wherein the six outputs are configured to be connectable in series or in parallel depending on configuration of the receptacle of the external device.

2. The battery pack according to claim 1,
wherein the battery cell is a lithium-ion battery with a nominal voltage of 3.6 V to 3.8 V.

3. The battery pack according to claim 1,
wherein the connecting module is configured to provide only one of following four configurations according to configuration of the receptacle of the external device when the connecting module is coupled to the receptacle:
a first configuration in which all of the six outputs are connected in series to provide a voltage of six times the first output voltage;
a second configuration in which every three of the six outputs are connected in series, and two pairs of three outputs in series are connected in parallel to provide a voltage of three times the first output voltage;
a third configuration in which every two of the six outputs are connected in series, and three pairs of the two outputs in series are connected in parallel to provide a voltage of twice the first output voltage; and
a fourth configuration in which all of the six outputs are connected in parallel to provide the first output voltage.

4. The battery pack according to claim 1,
wherein the six outputs are arranged to be symmetrical when the connecting module is viewed from its front.

5. A battery pack comprising:
a housing;
six battery modules accommodated in the housing, each of the battery modules including: first to eighth battery cells connected in series to each other; a first output terminal having one end that is connected to a positive electrode of the first battery cell; a second output terminal having one end that is connected to a negative electrode of the eighth battery cell; and sensing lines for monitoring statuses of the first to the eighth battery cells; wherein each of the battery modules is electrically independent and configured such that a potential between the first output terminal and the second output terminal of each of the battery modules provides a first output voltage; and
a connecting module formed at one end of the housing and configured to connect to a receptacle of an external device, comprising six outputs having positive outputs and negative outputs, and a sensing unit that is connected with each of the sensing lines, a positive connector of the output being connected in electrical one-to-one correspondence with other end of the first output terminal of the battery module, a negative connector being connected in electrical one-to-one correspondence with other end of the second output terminal of each of the battery modules, and the six outputs being configured to independently relay the first output voltage,
wherein the six outputs are configured to be connectable in series or in parallel depending on configuration of the receptacle of the external device.

6. The battery pack according to claim 5,
wherein the battery cell is a lithium iron phosphate battery with a nominal voltage of 3.1 V to 3.3 V.

7. The battery pack according to claim 5,
wherein the connecting module is configured to provide only one of following four configurations according to configuration of the receptacle of the external device when the connecting module is coupled to the receptacle:
a first configuration in which all of the six outputs are connected in series to provide a voltage of six times the first output voltage;
a second configuration in which every three of the six outputs are connected in series, and two pairs of three outputs in series are connected in parallel to provide a voltage of three times the first output voltage;
a third configuration in which every two of the six outputs are connected in series, and three pairs of the two outputs in series are connected in parallel to provide a voltage of twice the first output voltage; and
a fourth configuration in which all of the six outputs are connected in parallel to provide the first output voltage.

8. The battery pack according to claim 5,
wherein the six outputs are arranged to be symmetrical when the connecting module is viewed from its front.

9. A battery pack comprising:
a housing;
six battery modules accommodated in the housing, each of the battery modules including an output terminal and configured to independently provide a first output voltage through the output terminal; and
a connecting module formed at one end of the housing and configured to connect to a receptacle of an external device and having six outputs, each of the outputs being connected in one-to-one correspondence with each output terminal of the battery module and configured to independently relay the first output voltage to the receptacle,
wherein the six outputs are configured to be connectable in series or in parallel depending on configuration of the receptacle of the external device, and configured to provide only one of once, twice, three times, and six times the first output voltage to the external device depending on configuration of the receptacle.

10. A battery system comprising:
a battery pack including six battery modules and a connecting module; and
a plurality of devices including a receptacle electrically connectable with the battery pack; and obtaining a drive voltage when the battery pack and the receptacle are connected,
wherein each of the battery modules comprises an output and is configured to independently provide a first output voltage through the output, and the connecting module is configured to be connected with the receptacle of the plurality of devices to independently relay the first output voltage from each of the battery modules to the receptacle, and
the plurality of devices includes at least two of following configurations:
a first device requiring a first drive voltage for drive and including a first receptacle, the first receptacle including six output connectors each electrically connected with the output of the battery module, the output connectors being connected in series in units of three, and two pairs of the output connectors of which the three output connectors are connected in series being connected in parallel so that the first receptacle is configured to convert a voltage of three times the first output voltage to the first drive voltage;
a second device requiring a second drive voltage for drive and including a second receptacle, the second receptacle including six output connectors each electrically connected with the output of the battery module, and all of the output connectors being connected in parallel and configured so that the first output voltage is output as the second drive voltage;
a third device requiring a third drive voltage for drive and including a third receptacle, the third receptacle including six output connectors each electrically connected with the output of the battery module, the output connectors being connected in series in units of two, and three pairs of the output connectors of which the two output connectors are connected in series being connected in parallel so that the third receptacle is configured to convert a voltage of twice the first output voltage to the third drive voltage; and
a fourth device requiring a fourth drive voltage for drive and including a fourth receptacle, the fourth receptacle including six output connectors each electrically connected with the output of the battery module, all of the output connectors being connected in series, and the fourth receptacle being configured to convert a voltage of six times the first output voltage to the fourth drive voltage.
